(19) United States
(12) Patent Application Publication
(10) Pub. No.: US 2017/0334350 A1
(43) Pub. Date: Nov. 23, 2017

(54) Sensor Device for a Vehicle

(71) Applicant: Continental Teves AG & Co. oHG, Frankfurt (DE)

(72) Inventors: Klaus Rink, Rodenbach (DE); Oliver Witt, Frankfurt am Main (DE)

(73) Assignee: Continental Teves AG & Co. oHG, Frankfurt (DE)

(21) Appl. No.: 15/601,162

(22) Filed: May 22, 2017

(30) Foreign Application Priority Data
May 20, 2016 (DE) 10 2016 208 808.

(51) Int. Cl. B60Q 1/52; G06K 9/00; G01S 13/93; B60W 50/14; B60W 30/08; B60R 21/34; B60R 21/0134; B60Q 1/00; G08G 1/16; B60K 31/00

(52) U.S. Cl. CPC B60Q 1/525; G08G 1/166; G08G 1/163; G06K 9/00362; G01S 13/93; B60K 31/0008; B60W 30/08; B60R 21/34; B60R 21/0134; B60Q 1/0023; B60W 50/14

(57) ABSTRACT

The invention relates to a sensor device for a vehicle for detecting a road user in a vehicle environment, wherein the road user transmits a communication signal, with a first antenna and a second antenna, wherein the first antenna and the second antenna are designed to receive the communication signal with a phase displacement, a processor which is designed to determine a transmission direction of the communication signal on the basis of the phase displacement between the communication signal received at the first antenna and the communication signal received at the second antenna, and a distance sensor which is designed to capture angle-dependent distance measured variables of the vehicle environment, wherein the processor is designed to determine a position of the road user on the basis of the transmission direction of the communication signal and of the angle-dependent distance measured variables of the vehicle environment.

### CROSS REFERENCE TO RELATED APPLICATIONS

This U.S. patent application claims the benefit of a German patent application No. 10 2016 208 808.4, filed Oct. 15, 2014, of which is hereby incorporated by reference herein.

### TECHNICAL FIELD

The present invention relates to a sensor device and a method for detecting a road user with the sensor device.

### BACKGROUND

Some road users such as pedestrians, cyclists or motorcyclists are particularly vulnerable in road traffic. These road users are also referred to as vulnerable road users (VRU). Vehicle sensors in motor vehicles, such as passenger motor vehicles or trucks, can be used to detect VRUs. As precise and reliable a location of the VRUs by the vehicle sensors as possible is important.

For this purpose, a vehicle-side environment sensor system, for example a camera-based one, can be used. In an image acquisition, which the camera acquires from a vehicle environment, objects such as VRUs can be classified and located on the basis of an algorithm. However, it is frequently the case that VRUs who for example are concealed by other road users, for example, or approach quickly and transverse to the direction of travel of the driver, are not seen in time.

Furthermore, cooperative radio systems can be used, which are based on self-location of the VRU, for detecting the VRUs. The prerequisite for this is that both the VRU and the vehicle in the highway traffic are equipped with compatible transmitting and receiving units. In a self-locating method, for example a communication unit carried by a VRU, such as, say, a smartphone, determines the position of the VRU. This can take place by means of a GNSS sensor of the communication unit, a wireless-based location, for example via UMTS or LTE, or other, local, infrastructure-based location techniques, for example iBeacon. The detected position of the VRU can then be stored on a central server by means of a mobile data connection. The server can detect a vehicle position in the same way and can warn vehicles and VRUs if there is a risk of collision. However, this presumes that there is a constant communication link between the communication device of the VRU and the server on the one hand, as well as the vehicle and the server on the other hand.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY OF THE INVENTION

Therefore, an efficient concept for a vehicle for reliably detecting the position of a road user in a vehicle environment is desired.

According to a first aspect, a sensor device for a vehicle detects a road user in a vehicle environment. The road user transmits a communication signal. A first antenna and a second antenna are designed to receive the communication signal with a phase displacement therebetween. A processor is designed to determine a transmission direction of the communication signal on the basis of the phase displacement between the communication signal received at the first antenna and the communication signal received at the second antenna. A distance sensor is designed to capture angle-dependent distance measured variables of the vehicle environment. The processor is designed to determine a position of the road user on the basis of the transmission direction of the communication signal and of the angle-dependent distance measured variables of the vehicle environment. As a result, the position of the road user can be detected effectively.

A safety system of the vehicle, for example braking assistance, can be deployed on the basis of the detected position of the road user. Furthermore, the position of the road user can be detected without a self-location of the road user or a bidirectional communication between the vehicle and the road user.

Alternatively, the sensor device can have further antennae, for example a third antenna. Using three antennae makes, for example, a 3D capture of the environment possible. Using further antennae can help validate the plausibility of and/or improve the capture. Furthermore, by comparing run-times a third, asymmetrically arranged antenna makes it possible to avoid ambiguity in the results, for example uncertainty as to whether the road user is on the left-hand side or the right-hand side of the vehicle or behind or in front of the vehicle (depending on the arrangement of the antennae).

The vehicle can be a motor vehicle, in particular a multi-track motor vehicle such as a passenger motor vehicle or a truck, or a single-track motor vehicle such as a motorcycle. The vehicle can furthermore be a rail vehicle, a water vehicle or an aircraft, in particular an airplane or a rotary-wing aircraft. The vehicle can be designed for autonomous or highly-automated locomotion.

The road user can be a vulnerable road user (VRU) such as a pedestrian, a bicycle or a motorcycle. The road user can be a further vehicle, in particular a motor vehicle.

The road user can have a communication device, in particular a mobile communication device such as a smartphone, which transmits the communication signal. The communication device can be designed to transmit the communication signal after activation by the vehicle (trigger), or permanently, or periodically. The communication device can transmit the communication signal via a wireless communication interface, in particular a Bluetooth communication interface or an ultra-wideband communication interface.

The processor can be designed as a control unit (electronic control unit, ECU) of the vehicle, or be integrated in a control unit of the vehicle. The processor can furthermore be designed as a microprocessor. The processor can determine the transmission direction of the communication signal as an angle of arrival (AoA) of the communication signal. The angle of arrival can be an angle in respect of a longitudinal axis of the vehicle. The processor can furthermore be designed to determine the position of the road user as 2D or 3D position coordinates in the vehicle plane.

The communication signal which is received at the first antenna and the communication signal which is received at the second antenna can be identical up to the phase displacement. The phase displacement can be the result of a different distance from the first antenna and the second antenna to the road user, in particular to the communication device of the road user.

The phase displacement can be an angle-dependent measured variable. The detected phase displacement can be 0, for example if the road user is located directly in front of the vehicle.

The distance sensor can be an environment sensor such as a radar sensor, and can capture the angle-dependent distance measured variables at least for a section of the vehicle environment. The distance sensor can for example be designed to capture distance values within an 180° angle in the direction of travel of the vehicle. The distance measured variables can indicate a distance from objects or further road users to the vehicle.

According to an embodiment, the sensor device has a communication interface, wherein the first antenna and the second antenna can be connected to the communication interface, wherein the communication interface is designed to receive and process the communication signal received respectively at the first antenna and the second antenna. The advantage is achieved as a result that the communication signal can be captured effectively.

The communication interface can comprise a first antenna terminal for connecting the first antenna and a second antenna terminal for connecting the second antenna, or be connected to the respective antenna terminals by communication technology. The communication interface can be integrated in a communication device and/or a communication chip. The communication interface can furthermore comprise further antenna terminals for connecting further antennae.

According to an embodiment, the processor can be connected to the communication interface to capture the phase displacement of the communication signal received at the first antenna to the communication signal received at the second antenna. As a result, the processor can capture the phase displacement effectively.

The processor and/or the communication interface can be designed to compare the communication signal received with the first antenna and the communication signal received with the second antenna to capture the phase displacement.

According to an embodiment, the communication interface is designed as a Bluetooth communication interface, in particular according to the Bluetooth Low Energy Standard, or as an ultra-wideband communication interface for receiving the communication signal, wherein the communication signal is designed according to a corresponding communication standard. As a result, established, in particular non-proprietary, communication standards can be used for the communication signal and the communication interfaces.

The communication signal can be transmitted by the communication device of the road user via a Bluetooth communication interface or an ultra-wideband communication interface.

Furthermore, the first antenna and the second antenna can be designed for receiving Bluetooth and/or ultra-wideband communication signals.

According to an embodiment, the first antenna is installed in the vehicle at a first installation position, and the second antenna is installed in the vehicle at a second installation position, wherein the processor is designed to determine the transmission direction on the basis of the phase displacement between the communication signal received at the first antenna and the communication signal received at the second antenna and the respective installation position of the first antenna and of the second antenna. As a result, the transmission direction of the communication signal can be captured efficiently by taking into consideration the installation positions of the antennae.

The first antenna can be installed at the front of a vehicle and the second antenna can be installed at the rear of a vehicle. Furthermore, the vehicle antennae can be installed on opposite sides of the vehicle, for example on or in the left and right external rearview mirror.

The distance between the antennae should ideally be at most half the wavelength of the communication signal, for 2.4 GHz Bluetooth for example 6.2 cm, so that an unambiguous phase displacement between the incoming waves can be achieved and the range 0-180° can be captured. At greater distances between the antennae, ambiguous angles in the range of 0-180° can occur.

Furthermore, the sensor device can comprise further antennae which are installed in further vehicle positions. The antennae of the sensor device can form an antennae array. The greater the number of the antennae, the more accurately the transmission direction of the communication signal can be detected.

According to an embodiment, the communication signal comprises classification information of the road user, wherein the classification information defines a classification of the road user, for example pedestrian, cyclist or motorcyclist, wherein the processor is designed to detect the classification of the road user on the basis of the classification information of the communication signal. The advantage is achieved as a result that the processor can detect a type of road user. This information can be made available to a vehicle security system. Furthermore, on the basis of the information, the driver of the vehicle can be warned in a targeted manner about a pedestrian, a cyclist or a motorcyclist.

According to an embodiment, the communication signal comprises activity information of the road user, wherein the activity information defines an activity of the road user, for example making a telephone call, listening to music or jogging, wherein the processor is designed to detect the activity of the road user on the basis of the activity information of the communication signal. As a result, the processor can detect an activity of the road user. The road user is for example distracted, or the perceptive faculty of the road user is reduced, by the activity. The information about the activity of the road user can be made available to a vehicle security system.

According to an embodiment, the distance sensor comprises at least one radar sensor element which is designed to capture the angle-dependent distance measured variables for a section of the vehicle environment on the basis of a radar measurement. As a result, the distance measured variables can be captured efficiently. The radar sensor element can furthermore be designed to capture the distance measured variables in continuous time intervals to detect a change in the environment and/or a movement of the road user.

The distance measured variables can indicate distances between objects in the vehicle environment to the vehicle. The radar sensor element can capture the distance measured variables in a portion of the vehicle environment established by an angle of radiation. Distance measured variables can be captured in a 360° environment around the vehicle by combining several radar sensor elements.

According to an embodiment, the distance sensor is designed to transmit a communication request signal to the road user at continuous time intervals, wherein the distance sensor is designed to receive a communication response signal in response to the respective communication request signal, wherein the distance sensor is designed to capture the distance measured variables on the basis of a temporal duration between respectively transmitting the communication request signal and detecting reception of the respective communication response signal. The distance measured variables can be captured also on the basis of a bidirectional communication between the vehicle and the road user, without environment sensors, such as radar sensors, being required for this. The processor can also detect a movement of the road user by continuously capturing the distance measured variable.

The communication request signal can be received by a communication device of the road user, in particular a smartphone. The communication device can transmit the communication response signal to the vehicle after a preset time interval. The processor can determine a distance measured variable between the road user and the vehicle on the basis of a round-trip time-of-flight (RToF) measurement, taking the preset time interval into consideration.

According to an embodiment, the distance sensor comprises a further communication interface, in particular an ultra-wideband communication interface, wherein the further communication interface of the distance sensor is designed for transmitting the communication request signal and/or for receiving the communication response signal, in particular to transmit and to receive as ultra-wideband communication signals. As a result, an efficient bidirectional communication can take place between the vehicle and the road user.

The further communication interface can comprise a transponder or be designed as a transponder.

According to an embodiment, the further communication interface can be connected to the first antenna and the second antenna to transmit the communication request signal and/or to receive the communication response signal. The communication request signal and the communication response signal can be captured particularly efficiently. Furthermore, the communication response signal can correspond to the communication signal.

According to an embodiment, the further communication interface is designed by the communication interface. In other words: the communication interface and the further communication interface can be identical and designed as a common communication interface. The common communication interface can be designed to capture distances and angles. As a result, both the direction of beam and the distance measured variables can be captured on the basis of a communication with the road user by means of a communication interface of the vehicle. The complexity of the sensor device can be considerably reduced as a result. Consequently, production costs of the sensor device can be reduced and the installation space required for the sensor device in the vehicle can be reduced.

According to an embodiment, the sensor device is designed to actuate a safety application of the vehicle in response to determining the position of the road user by a detection signal, wherein the detection signal indicates the position of the road user. As a result, the safety application can be efficiently carried out taking the road user, in particular the position, the type and the activity of the road user into consideration.

According to a second aspect, a method for detecting a road user in a vehicle environment is described. The road user transmits a communication signal received with a first antenna and a second antenna. The received communication signal is phase-displaced between the first antenna and the second antenna. A transmitting device of the communication signal is determined on the basis of the phase displacement between the communication signal received at the first antenna and the communication signal received at the second antenna. Angle-dependent distance measured variables of the vehicle environment are captured, and a position of the road user on the basis of the transmission direction of the communication signal and of the angle-dependent distance measured variables of the vehicle environment is determined. As a result, the position of the road user can be detected efficiently. A safety system of the vehicle, for example braking assistance, can be deployed on the basis of the detected position of the road user. Furthermore, the position of the road user can be detected without a self-location of the road user or a bidirectional communication between the vehicle and the road user.

According to a third aspect, the method relates to a vehicle, in particular a motor vehicle, having a sensor device as described above. The method can be implemented in hardware and/or software.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE FIGURES

Further embodiments are explained in more detail with reference to the attached figures, in which:

FIG. 1 shows a schematic representation of a sensor device for detecting a road user in a vehicle environment;

FIG. 2 shows a schematic representation of a vehicle with the sensor device from FIG. 1;

FIG. 3 shows a schematic representation of the determining of the position of a road user; and

FIG. 4 shows a flow diagram of a method for detecting a road user in a vehicle environment.

### DETAILED DESCRIPTION

In the following detailed description, reference is made to the attached drawings which form a part thereof, and in which specific embodiments in which the invention can be carried out are shown for illustration. It is self-evident that other embodiments can also be used and structural or logical changes can be made without deviating from the concept of the present invention. The following detailed description therefore should not be understood in a limiting sense. Furthermore, it is self-evident that the features of the different embodiments described herein can be combined with one another unless specifically indicated otherwise.

The aspects and embodiments are described with reference to the drawings, wherein the same reference numerals relate generally to the same elements. In the following description, for purposes of explanation, numerous specific details are shown in order to convey a detailed understanding of one or more aspects of the invention. However, it may be apparent to a person skilled in the art that one or more aspects or embodiments can be carried out with fewer specific details. In other cases, known structures and elements are represented in schematic form in order to simplify the description of one or more aspects or embodiments. It is self-evident that other embodiments can be used and structural or logical changes can be made without deviating from the concept of the present invention.

Although a specific feature or a specific aspect of an embodiment may have been disclosed with reference to only one of several implementations, such a feature or such an aspect can also be combined with one or more other features or aspects of other implementations, as may be desirable and advantageous for a given or specific application. Furthermore, to the extent in which the expressions “include”, “have”, “with” or other variants thereof are used, such expressions are similarly intended to be inclusive. The expressions “coupled” and “connected” may have been used together with derivations thereof. It is self-evident that such expressions are used to indicate that two elements cooperate or integrate with one another regardless of whether or not they are in direct physical or electrical contact or not in direct contact with one another. Moreover, the expression “by way of example” is intended to be understood merely as an example instead of the indication of the best or optimum.

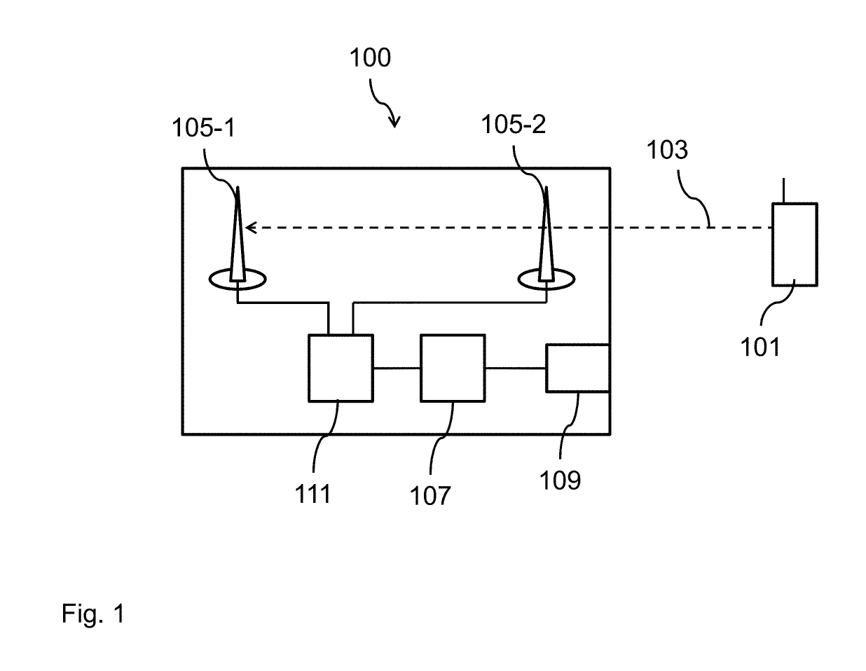

FIG. 1 shows a schematic representation of a sensor device 100 for detecting a road user in a vehicle environment according to an embodiment. The road user has a communication device which transmits a communication signal 103.

The sensor device 100 comprises a first antenna 105-1 and a second antenna 105-2, wherein the first antenna 105-1 and the second antenna 105-2 are designed to receive the communication signal 103 with a phase displacement, a processor 107 which is designed to determine a transmission direction of the communication signal 103 on the basis of the phase displacement between the communication signal 103 received at the first antenna 105-1 and the communication signal 103 received at the second antenna 105-2, and a distance sensor 109 which is designed to capture angle-dependent distance measured variables of the vehicle environment. The processor 107 is also designed to determine a position of the road user on the basis of the transmission direction of the communication signal 103 and of the angle-dependent distance measured variables of the vehicle environment.

The sensor device 100 can have further antennae, for example a third antenna. Using three antennae makes, for example, a 3D capture of the environment possible. Using further antennae can help validate the plausibility of and/or improve the capture. Furthermore, by comparing run-times a third, asymmetrically arranged antenna makes it possible to avoid ambiguity in the results, for example uncertainty as to whether the road user is on the left-hand side or the right-hand side of the vehicle or behind or in front of the car (depending on the arrangement of the antennae).

The vehicle can be a motor vehicle, in particular a multi-track motor vehicle such as a passenger motor vehicle or a truck, or a single-track motor vehicle such as a motorcycle. The vehicle can furthermore be a rail vehicle, a water vehicle or an aircraft, in particular an airplane or a rotary-wing aircraft. The vehicle can be designed for autonomous or highly-automated locomotion.

The road user can be a vulnerable road user (VRU) such as a pedestrian, a bicycle or a motorcycle. The road user can be a further vehicle, in particular a motor vehicle.

The road user can have a communication device 101, in particular a mobile communication device such as a smartphone, which transmits the communication signal 103. The communication device 101 can transmit the communication signal 103 via a wireless communication interface, in particular a Bluetooth communication interface or an ultra-wideband communication interface.

The processor 107 can be designed as a control unit (electronic control unit, ECU) of the vehicle, or be integrated in a control unit of the vehicle. The processor 107 can furthermore be designed as a microprocessor. The processor 107 can determine the transmission direction of the communication signal 103 as an angle of arrival (AoA) of the communication signal 103. The angle of arrival can be an angle in respect of a longitudinal axis of the vehicle. The processor 107 can furthermore be designed to determine the position of the road user as 2D position coordinates in the vehicle plane.

The communication signal 103 which is received at the first antenna 105-1 and the communication signal 103 which is received at the second antenna 105-2 can be identical up to the phase displacement. The phase displacement can be the result of a different distance from the first antenna 105-1 and the second antenna 105-2 to the road user, in particular to the communication device 101 of the road user.

The first antenna 105-1 can be installed at a first installation position at the vehicle, and the second antenna 105-2 can be installed at a second installation position at the vehicle. For example, the first antenna 105-1 is installed at a front of a vehicle, in particular at a front fender, and the second antenna 105-2 can be installed at a rear of a vehicle, in particular at a rear fender. Furthermore, the first antenna 105-1 and the second antenna 105-2 can each be installed at a driver or passenger side of the vehicle, for example in or on a wing mirror on the driver or passenger side.

The distance between the antennae 105-1, 105-2, should ideally be at most half the wavelength of the communication signal 103, for 2.4 GHz Bluetooth for example 6.2 cm, so that an unambiguous phase displacement between the incoming waves can be achieved and the range 0-180° can be captured. At greater distances between the antennae 105-1, 105-2, ambiguous angles in the range of 0-180° can occur.

Furthermore, the sensor device 100 in FIG. 1 comprises a communication interface 111, wherein the first antenna 105-1 and the second antenna 105-2 can be connected to the communication interface 111. The communication interface 111 can be designed to receive and process the communication signal 103 received respectively at the first antenna 105-1 and at the second antenna 105-2.

The communication interface 111 can comprise a first antenna terminal for connecting the first antenna 105-1 and a second antenna terminal for connecting the second antenna 105-2 or be connected to the respective antenna terminals by communication technology. The communication interface 111 can be integrated in a communication device and/or a communication chip.

The distance sensor 109 can be an environment sensor such as a radar sensor, and can capture the angle-dependent distance measured variables at least for a section of the vehicle environment. The distance sensor 109 can for example be designed to capture distance values within an 180° angle in the direction of travel of the vehicle. The distance measured variables can indicate a distance from objects or further road users to the vehicle.

In an alternative embodiment, the distance sensor 109 comprises a further communication interface which is designed to capture the distance between the road user 201 via a time offset between a transmission of a communication request signal to the road user 201 and the reception of a communication response signal from the road user 201. The transmission angle of the communication response signal can additionally be captured by the processor 107. The position of the road user 201 can be captured on the basis of the thus-determined distance between the road user 201 and the transmission angle of the communication response signal.

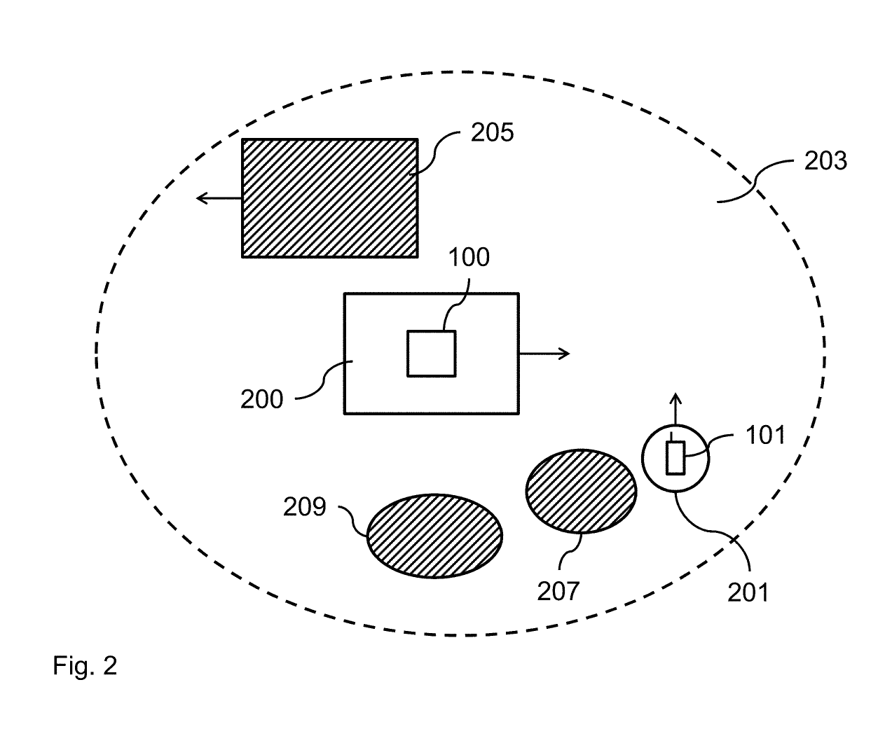

FIG. 2 shows a schematic representation of a vehicle 200 having the sensor device 100 from FIG. 1 according to an embodiment.

In FIG. 2, the road user 201 with the communication device 101 is located in the vehicle environment 203. Furthermore, a further vehicle 205, and objects 207, 209, for example plants which can conceal the sight of the vehicle 200 by the road user 201, is/are located in the vehicle environment 203.

In FIG. 2, the vehicle 200 moves in the direction of the arrow, from left to right. The road user 201, for example a pedestrian or a cyclist, moves transversely to the direction of movement of the vehicle 200, with the result that a dangerous situation can arise if a driver of the vehicle 200 does not notice the road user 201.

The sensor device 100, in particular the processor 107 of the sensor device 100, can be designed to actuate a safety system of the vehicle 200, in particular a traffic monitoring system of the vehicle 200, with the detected position of the road user 201, when the position of the road user 201 has been determined.

With the sensor device 100, road users 201 can also be detected even in the event of being concealed from view, for example by an object 207 between the road user 201 and the vehicle 200, in particular if the distance from the road user 201 is likewise detected via a communication signal 103.

According to an embodiment, the communication signal 103 comprises classification information of the road user 201. The classification information can define a classification of the road user 201, for example as a school-age child, a cyclist or a wheelchair user. The processor 107 can be designed to classify the road user 201 on the basis of the classification information.

According to an embodiment, the communication signal 103 comprises activity information of the road user 201. The activity information can define or comprise an activity of the road user 201, for example “is listening to music”, “is making a telephone call”, “is jogging” or “has an appointment in 5 minutes”. The processor 107 can be designed to detect the activity of the road user 201 on the basis of the activity information.

According to an embodiment, the road user 201 can be located or positioned by the sensor device 100 regardless of outdoor light conditions.

According to an embodiment, the sensor device 100, in particular the antennae 105-1, 105-2, is designed to detect the communication signal 103 from a 360° environment around the vehicle 200.

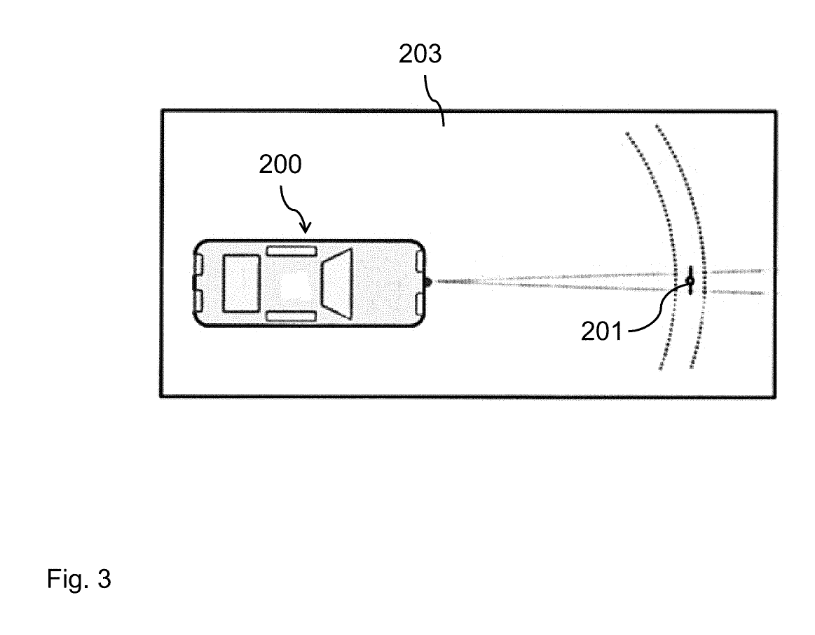

FIG. 3 shows a schematic representation of the determining of the position of a road user 201 according to an embodiment.

The sensor device 100 of the vehicle 200 can detect the road user 201 in the vehicle environment 203 on the basis of a combination of distance and angular measurements.

The greater the accuracy of the angular measurement, represented by the two dashed lines coming out from the vehicle 200 in FIG. 3, and the distance measurement, represented by the two curved lines in FIG. 3, the more accurately the position of the road user 201 can be detected.

According to an embodiment, the communication signal 103 is designed according to the Bluetooth Low Energy (BLE) Standard.

According to an embodiment, the communication device 101 of the road user 201, in particular a transponder of the communication device 101, transmits the BLE communication signal cyclically, in regular time intervals of up to 20 milliseconds, in the form of a so-called advertising packet. The antennae 105-1, 105-2 of the vehicle 200 can receive the advertising packet, and the processor 107 can capture the reception angle or transmission angle of the BLE communication signal on the basis of a phase-difference measurement.

When using the BLE communication signal and the antennae 105-1, 105-2 to determine an angle, a second sensor system, for example a radar sensor, can be used to measure the distance. The radar sensor can capture a distance value at any angle in the field of vision of the vehicle 200.

When using two separate systems for determining angle and distance is that the communication device 101 of the road user 201 needs to have only one BLE functionality. A bidirectional communication between the vehicle 200 and the road user 201 does not take place, whereby the complexity of the detection process is clearly reduced.

Furthermore, the following may apply for the sensor device 100 when using a BLE communication signal for the angular measurement: (i) use of an established international communication standard; (ii) use of a particularly energy-saving communication standard, (iii) possibility for the communication device 101 of the road user 201 to enter a standby or sleep mode between the transmission of advertising packets, in order to save electricity, (iv) availability of Bluetooth Low Energy as widely-used technology for the majority of smartphones and smartwatches available commercially. For example, most modern smartphones are equipped with corresponding BLE communication interfaces. BLE is also supported by many modern operating systems such as iOS5, Android 4.3 or AndroidWear.

According to an embodiment, the communication signal 103 is designed according to the ultra-wideband (UWB) standard.

A distance and angular measurement to locate the road user 201 can take place in each case on the basis of the UWB communication signal without a separate distance sensor being required.

The angular measurement can, as with the BLE communication signal, take place via a phase-difference measurement and the distance measurement can take place on the basis of a round-trip time-of-flight (RToF) measurement. The communication interface 111 of the vehicle 200 can transmit a UWB communication request signal to the road user 201 and, in response to the transmission of the UWB communication request signal, receive a UWB communication response signal from the road user 201 or from the communication device 101 of the road user 201. The distance measurement can take place on the basis of a temporal duration between transmission of the UWB communication request signal and reception of the UWB communication response signal.

The communication device 101 of the road user 201 can transmit the UWB communication response signal to the vehicle 200 after a preset time interval. The processor 107 can take the preset time interval into consideration when determining the distance measured variable.

The distance measurement and the angular measurement can take place via the same antennae 105-1, 105-2 and the same communication interface 111 of the vehicle 200. A separate distance sensor, for example a radar measuring device, is no longer required.

In particular, the UWB communication response signal and UWB communication signal, on the basis of which the angular measurement takes place, are identical, with the result that the road user 201 can be positioned on the basis of the evaluation of a single received UWB communication signal.

Because of the high bandwidth of UWB communication signals, reflected signals can be clearly better distinguished from signals which arrive directly at the vehicle 201 from the road user 201. Reflected signals which lead to erroneous distance measurements, for example too great a distance, and to erroneous angular measurements, can thus be ignored.

Moreover, because of the higher carrier frequency of a UWB communication signal of at most 10.6 GHz, a wavelength of up to 4.4 times smaller arises, compared with the ISM band at 2.4 GHz. This makes a clearly smaller distance between individual antennae 105-1, 105-2 of the antennae array possible and thus a smaller installation size of the sensor device 100.

The following may apply for the sensor device 100 when using a UWB communication signal for the angular measurement: (i) use of an established communication standard; (ii) a smaller dimension of the antennae array because of a smaller wavelength of the communication signal 103, (iii) a high freely available bandwidth.

The high freely available bandwidth makes a particularly efficient distinction between reflected and direct signals with a resolution of up to 30 cm at 500 MHz bandwidth with ΔR=c/B possible, wherein ΔR is a multipath detection resolution, c is the speed of light and B is a bandwidth of the communication signal 103.

When locating by means of phase-difference measurement and distance measurement, there is no prerequisite for a GNSS sensor in the communication device 101 of the road user 201, wireless network coverage or local radio infrastructure, for example Bluetooth Beacons. Instead, communication takes place directly between the road user 201 and the vehicle 200. An intermediary server for transmitting the position can thus also be dispensed with, whereby latency time when locating the road user 201 can be shortened.

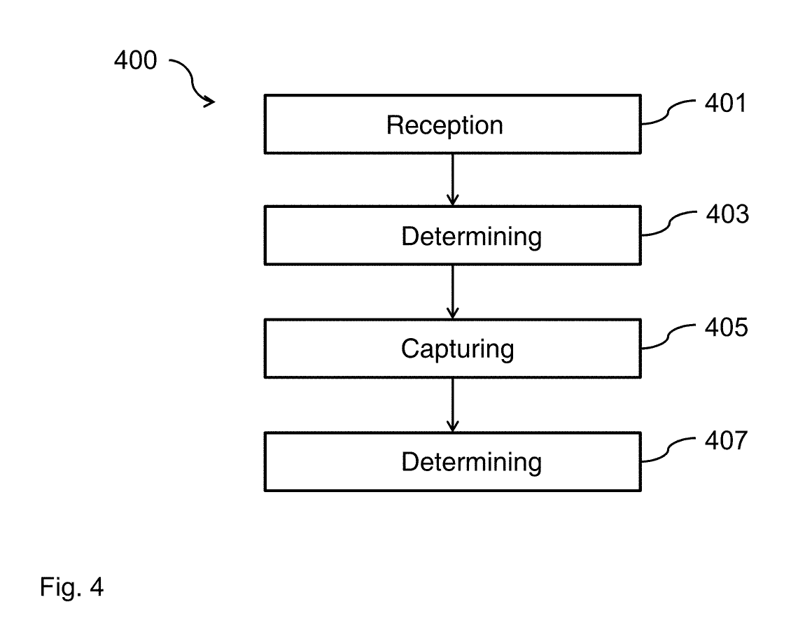

FIG. 4 shows a flow diagram of a method 400 for detecting the road user 201 in the vehicle environment 203 according to an embodiment, wherein the road user 201 transmits the communication signal 103.

The method 400 discloses reception 401 of the communication signal 103 with the first antenna 105-1 and the second antenna 105-2. The received communication signal 103 is phase-displaced between the first antenna 105-1 and the second antenna 105-2. The transmission direction of the communication signal 103 is determined, 403, on the basis of the phase displacement between the communication signal 103 received at the first antenna 105-1 and the communication signal 103 received at the second antenna 105-2. Angle-dependent distance measured variables of the vehicle environment 203 are captured, 405. The position of the road user 201 is determined, 407, on the basis of the transmission direction of the communication signal 103 and of the angle-dependent distance measured variables of the vehicle environment 203.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A sensor device for a vehicle for detecting a road user in a vehicle environment comprising:
a communication signal transmitted by the road user;
a first antenna and a second antenna to receive the communication signal with a phase displacement therebetween;
a processor to determine a transmission direction of the communication signal on the basis of the phase displacement between the communication signal received at the first antenna and the communication signal received at the second antenna; and
a distance sensor to capture angle-dependent distance measured variables of the vehicle environment;
wherein the processor determines a position of the road user on the basis of the transmission direction of the communication signal and of the angle-dependent distance measured variables of the vehicle environment;
a communication interface connected to the first antenna and the second antenna to receive and process the communication signal received at the first antenna and the second antenna respectively;
wherein the communication interface is one of: a Bluetooth communication interface, a Bluetooth communication interface with Low Energy Standard, and an ultra-wideband communication interface; and
wherein the communication signal is designed according to a corresponding communication standard.

2. The sensor device according to claim 1, wherein the processor can be connected to the communication interface to detect the phase displacement of the communication signal received at the first antenna to the communication signal received at the second antenna.

3. The sensor device according to claim 1, wherein the first antenna is installed in the vehicle at a first installation position, and the second antenna is installed in the vehicle at a second installation position, wherein the processor is designed to determine the transmission direction on the basis of the phase displacement between the communication signal received at the first antenna and the communication signal received at the second antenna and the respective installation position of the first antenna and of the second antenna.

4. The sensor device according to claim 1, wherein the communication signal comprises classification information of the road user, and wherein the processor is designed to detect the classification of the road user on the basis of the classification information of the communication signal

5. The sensor device according to claim 4, wherein the classification of the road user is one of: pedestrian, cyclist or motorcyclist.

6. The sensor device according to claim 1, wherein the communication signal comprises activity information of the road user, wherein the activity information defines an activity of the road user, and wherein the processor is designed to detect the activity of the road user on the basis of the activity information of the communication signal

7. The sensor device according to claim 6, wherein the activity of the road user is one of: making a telephone call, listening to music or jogging.

8. The sensor device according to claim 1, wherein the distance sensor comprises at least one radar sensor element which is designed to capture the angle-dependent distance measured variables for a section of the vehicle environment on the basis of a radar measurement.

9. The sensor device according to claim 1, wherein the distance sensor is designed to transmit a communication request signal to the road user at continuous time intervals, wherein the distance sensor is designed to receive a communication response signal in response to the respective communication request signal, wherein the distance sensor is designed to capture the distance measured variables on the basis of a temporal duration between respectively transmitting the communication request signal and detecting reception of the respective communication response signal.

10. The sensor device according to claim 9, wherein the distance sensor comprises a further communication interface for at least one of: transmitting the communication request signal and receiving the communication response signal.

11. The sensor device according to claim 10, wherein the further communication interface is an ultra-wideband communication interface in particular to transmit and to receive as ultra-wideband communication signals.

12. The sensor device according to claim 10, wherein the further communication interface can be connected to the first antenna and the second antenna to do at least one of: transmit the communication request signal and receive the communication response signal.

13. The sensor device according to claim 1, wherein the sensor device is designed to actuate a safety application of the vehicle in response to determining the position of the road user by a detection signal, wherein the detection signal indicates the position of the road user.

14. A method for detecting a road user in a vehicle environment comprising:
receiving a communication signal from the road user with a first antenna and a second antenna, wherein the communication signal is phase-displaced at the first antenna and at the second antenna;
determining a transmission direction of the communication signal on the basis of the phase displacement between the communication signal received at the first antenna and the communication signal received at the second antenna;
capturing angle-dependent distance measured variables of the vehicle environment; and
determining a position of the road user on the basis of the transmission direction of the communication signal and the angle-dependent distance measured variables of the vehicle environment.
